(19) United States
(12) Patent Application Publication
(10) Pub. No.: US 2009/0293366 A1
(43) Pub. Date: Dec. 3, 2009

(54) WALL, DOOR OR WINDOW ELEMENT

(76) Inventor: Dirk Wefer, Bremen (DE)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 12/323,786

(22) Filed: Nov. 26, 2008

(30) Foreign Application Priority Data
Dec. 7, 2007 (DE) 102007059222.3

(51) Int. Cl. E05D 15/06

(52) U.S. Cl. 49/425

(57) ABSTRACT

A panel-like wall or door element which can be displaced in particular on supporting rollers comprises an all-round frame (10), and the latter comprises interconnected profiles, namely supporting profiles (11) and transverse profiles. The profiles are designed for the purpose of fitting external panels on lateral abutment surfaces (16) by means of adhesive bonding or adhesive tape (17), with stabilizing means, namely one or more stabilizing plates (40) preferably being fitted in the center. These enter into a guide groove (23) of the profiles.

### STATEMENT OF RELATED APPLICATIONS

This application claims the benefit under 35 USC 119 of German Patent Application No. DE 10 2007 059 222.3 having a filing date of 7 Dec. 2007, which is incorporated herein in its entirety by this reference.

### BACKGROUND OF THE INVENTION

1. Technical Field

The invention relates to a wall, door or window element having at least one filler panel and a frame which is made up of shaped profiles produced, in particular, by deep drawing or thermoforming and which surrounds the panel along its periphery.

2. Prior Art

According to the prior art, the elements mentioned here have a continuous panel made of wood or wood-based material, glass, metal, plastic or the like. The panel is surrounded by the frame. The frame-forming profiles have grooves into which a peripheral region of the panel enters. The profiles form upright supporting profiles and top and bottom crossmembers. If the elements are configured with a sliding function, the top and bottom crossmembers have rollers which can be displaced in rails at the bottom and top.

### BRIEF SUMMARY OF THE INVENTION

It is an object of the invention to improve elements of the above type in respect of construction and external appearance.

In order to achieve this object the element according to the invention is characterized by the following features:

a) the panel is fastened on a free side surface of the frame (exclusively) by a concealed connecting means, in particular by adhesive,

b) the profiles are secured in respect of precise positioning, at least in the region of connecting or joining locations, by one or more plate-like centering or adjusting means, and

c) the centering or adjusting means enters/enter into guide grooves of the adjacent profiles.

The special feature of the present elements resides, in the first instance, in the fact that the panel, in particular a panel consisting of glass or similar material, is fastened on the outside of the profile without use being made of transversely directed screws or other connecting means, in particular exclusively by adhesive bonding. In order to improve the stability of the frame, and in particular in order to secure the frame parts during assembly of the elements, one or more means are provided for positioning within the frame, at least in the region of joining locations formed at the corners of the profiles, for the purpose of aligning and securing the same. The profiles are provided with a groove into which the centering or adjusting means enters/enter. The plate-like means may advantageously be fitted in the bottom and top regions of the frame, but may also be designed as a continuous panel which fills the frame.

The frame-forming profiles are designed in a particular manner. For the purpose of fitting the (glass) panels preferably on both sides of the frame, profile legs are formed with smooth outer or side surfaces in order for the glass panels to be fastened by means of adhesive, in particular by means of adhesive strips. On the free periphery, the profile forms at least one transversely directed leg, preferably two transversely directed legs, for the support or abutment of a free periphery of the glass panel(s). The profile crosspieces, furthermore, are designed such that they have a preferably central groove for accommodating the adjusting or securing means.

### BRIEF DESCRIPTION OF THE DRAWINGS

Further special features of the invention will be explained in more detail hereinbelow with reference to the drawings, in which:

FIG. 1 shows a perspective illustration of a (door) element with its individual parts.

FIG. 2 shows a schematic view of a wall element.

FIG. 3 shows, on an enlarged scale, the detail III in FIG. 2.

FIG. 4 shows, likewise on an enlarged scale, the detail IV in FIG. 2.

FIG. 5 shows a diagrammatic illustration of the wall element.

FIG. 6 shows, on an enlarged scale, a cross section VI-VI from FIG. 5.

FIG. 7 shows, likewise on an enlarged scale, a detail-form section VII-VII from FIG. 5.

FIG. 8 shows a further diagrammatic illustration of the elements.

FIG. 9 shows, on an enlarged scale, a detail-form section IX-IX from FIG. 8.

FIG. 10 shows a perspective illustration of the top region of the frame.

### DETAILED DESCRIPTION OF PREFERRED EMBODIMENTS

The exemplary embodiments of an element which are illustrated in the drawings form a displaceable door, also known as a sliding door. The door element comprises an all-round, closed frame 10 made up of profiles or profile portions. The frame 10 forms upright supports or supporting profiles 11, 12 and transversely directed members or transverse profiles 13, 14. The profiles 11 . . . 14 are hollow profiles, namely extruded metal or plastic profiles. The upright profiles 11, 12, on the one hand, and the transverse profiles 13, 14, on the other hand, are fitted together, and connected to one another, in the region of frame corners. In the case of the present exemplary embodiment, the supporting profiles 11, 12 extend over the entire height of the frame 10. The transverse profiles 13, 14 are arranged between the supporting profiles 11,12, butt against bottom and top end regions of the supporting profiles 11, 12 and are connected thereto.

The frame 10 is the carrying structure for at least one element panel, which extends in particular over the entire extent of the frame 10. The element panel is preferably a glass panel 15. One special feature resides in the arrangement of the element or glass panel 15 on the frame 10. The latter is provided on at least one side, in the present case on both sides, with planar abutment surfaces 16 which extend all the way round, are aligned in relation to one another and are intended for the element or glass panel 15. Accordingly, the glass panel 15 butts against the outside of the frame 10 or of the profiles 11, 12, 13, 14 and is connected thereto by concealed means. In particular, the glass panel 15 is fastened on the frame 10 by adhesive bonding, at least in the region of selected profile portions, but preferably all the way around. Accordingly, the glass panel 15 largely has the same dimensions as those of the frame 10.

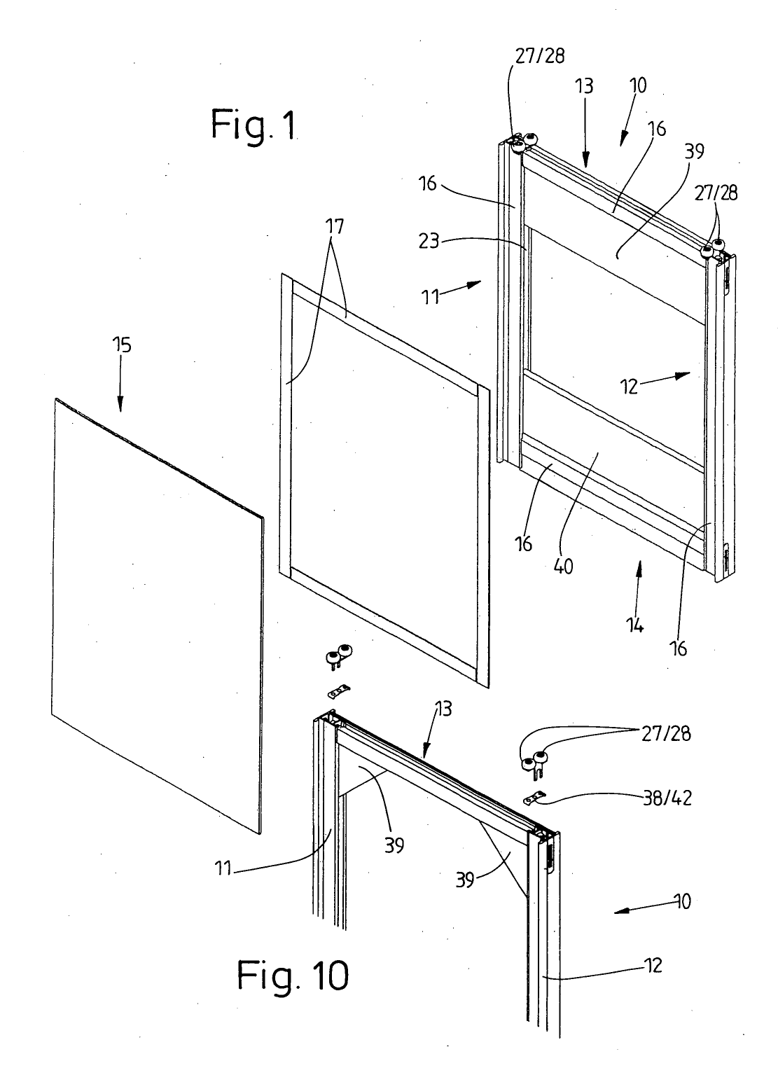

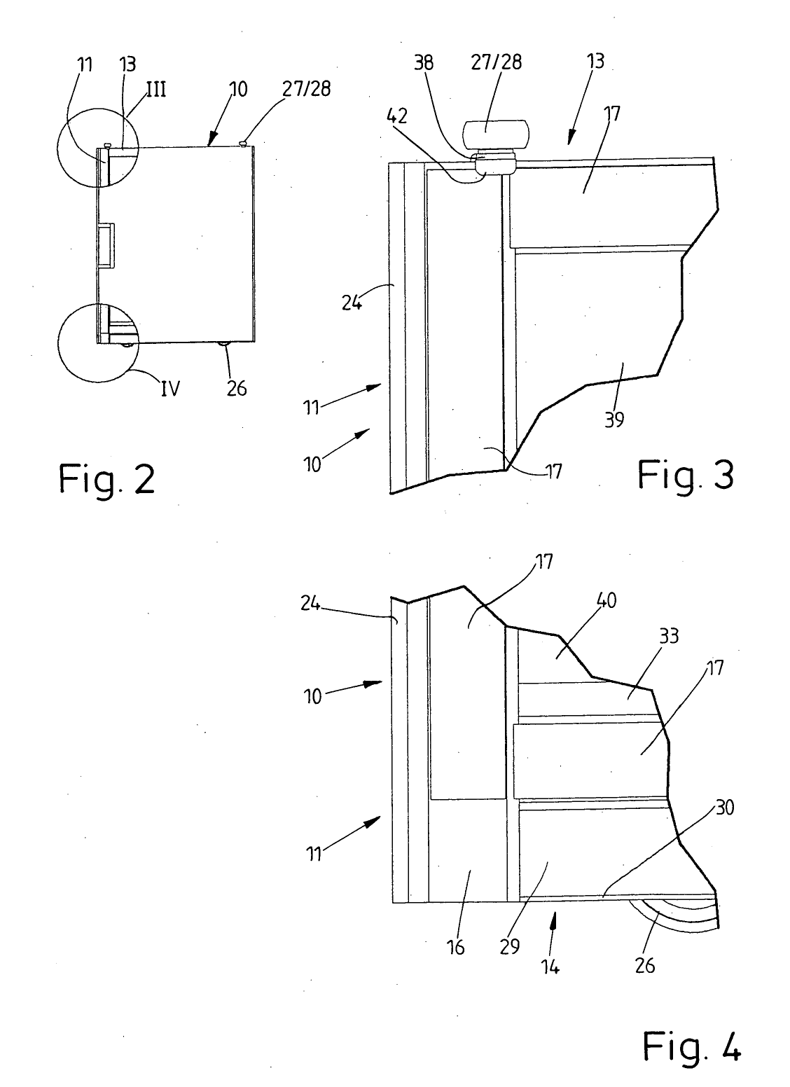

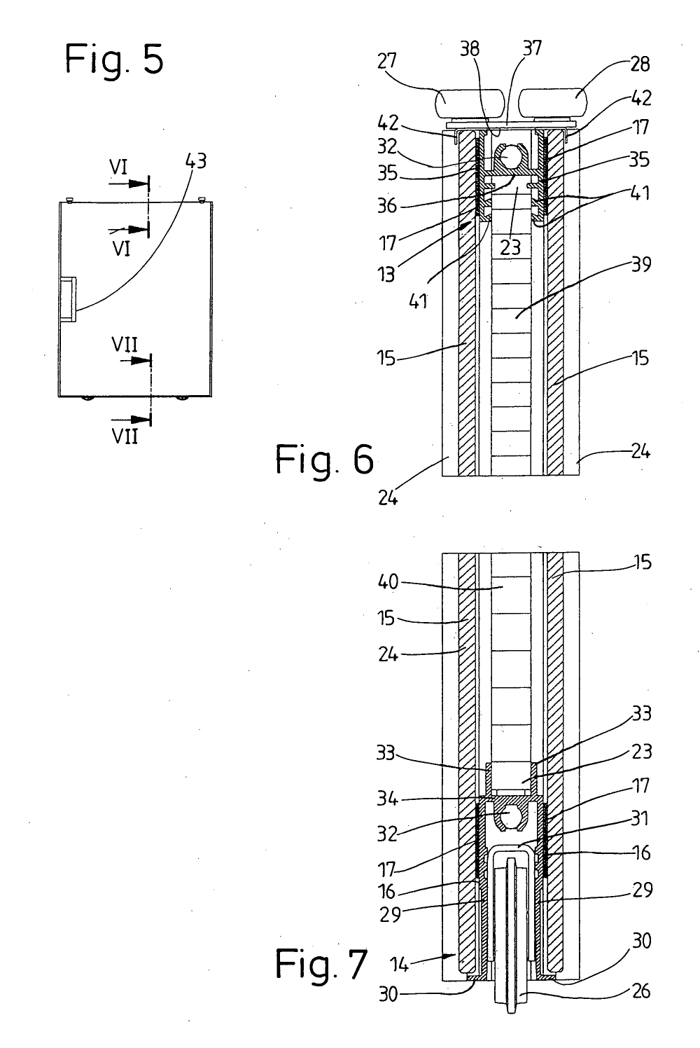

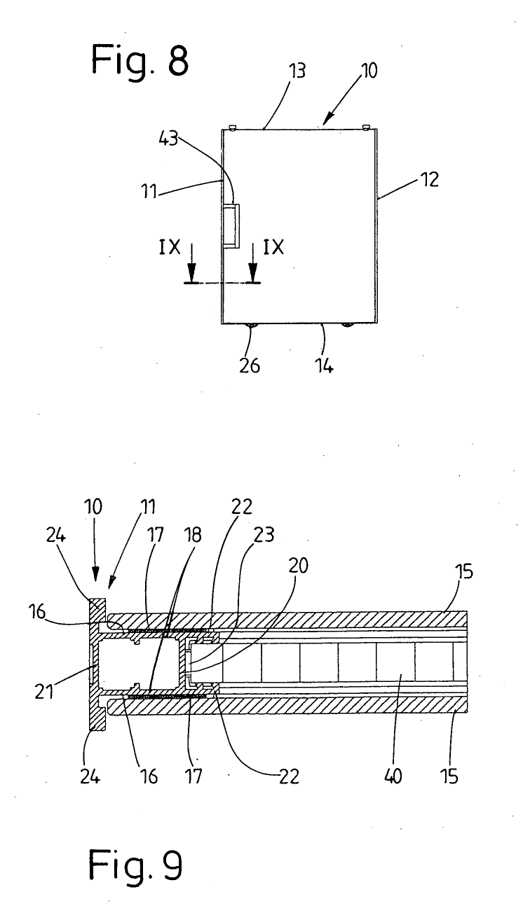

One special feature resides in the use of adhesive strips or adhesive tapes 17 for connecting the glass panel 15 to the frame 10. The double-sided adhesive tape 17, preferably in the form of 4613 brand from 3M, is applied as the glass panel 15 is fitted on the abutment surfaces 16 of the profiles 11, 12, 13, 14. An all-around, closed frame made of adhesive tape 17 is preferably created (FIG. 1), and a gap-free adhesive bonding is therefore achieved. The glass panel 15 is then pressed against the adhesive tape 17 in the region of the frame parts to produce a durable connection.

The glass panel 15 is preferably provided with an anti-shatter means, in particular with an anti-shatter film (not shown), fitted on one side. This film is located on the inside, that is to say in the direction towards the frame 10. In order to create an effective connection with durable adhesive bonding, it is expedient to provide both the abutment surfaces 16 and the strip-like peripheral regions of the glass panel 15 beforehand with a primer, in particular with a primer 94 brand from 3M.

The frame 10 or the profiles 11, 12, 13, 14 are shaped in a particular manner in order to be fit for purpose. The upright profiles, that is to say the supporting profiles 11, 12, are designed to correspond to one another. The transverse profiles 13, 14 differ, in respect of configuration and dimensioning, from the supporting profiles 11, 12 and from one another. In the case of the exemplary embodiment shown, the profiles 11, 12, 13, 14 are geared towards accommodating two glass panels 15, that is to say with in each case one glass panel 15 on both sides of the frame 10.

The upright supporting profiles 11, 12 comprise a basic or standard profile (FIG. 9). Side walls 18 of the profile bound a channel-like cavity 19, which is bounded by an inner transverse wall 20 and by a peripheral outer wall 21. The side walls 18 are extended inwards beyond the transverse wall 20 to form legs 22 as a lateral boundary of the central U-shaped guide groove 23. The latter extends over the entire length of the supporting profiles 11, 12 and continues in the region of the transverse profiles 13, 14.

The outer wall 21 is also designed in a particular manner, that is to say it is extended laterally beyond the side walls 18 to form a supporting leg 24 which is arranged at least on one side, and in the case of the present exemplary embodiment is formed on both sides. This supporting leg serves as a stop or abutment for the element or glass panel 15, which may come to bear against the associated supporting leg 24. The supporting leg 24 is dimensioned such that it projects freely beyond the plane of the glass panel 15 and thus forms an edge guard for the glass panel 15. Furthermore, the supporting leg 24 is provided with a groove 25. The latter is arranged adjacent to the side walls 18 and creates a peripheral elevation of the supporting legs 24 for the abutment of the glass panel 15. The profile projection formed by the correspondingly dimensioned supporting legs 24 creates an edge guard for the free peripheries of the glass panels 15. Furthermore, functional means for the door, for example a handle 43, may be fitted on the supporting legs 24.

The present exemplary embodiment of a door or wall element can be displaced by means of rollers. Bottom rollers, namely supporting rollers 26, can be displaced on a bottom running rail (not shown). The element has two spaced-apart supporting rollers 26 which are mounted in a rotatable manner on or in the bottom transverse profile 14, at a distance from the upright supporting profiles 11, 12.

Guide rollers 27, 28 are arranged on the top side, namely in the region of the top transverse profile 13 and/or at the top end of the supporting profiles 11, 12. These guide rollers 27, 28, which are located in pairs one beside the other and have a vertical axis of rotation, serve for laterally supporting and/or guiding the element in a top rail (not shown), which may possibly be arranged on a ceiling of a building.

The bottom frame profile, namely the transverse profile 14, is designed in a particular manner, namely with a profile which is open in the downward direction on account of upright profile walls 29—analogous to the side walls 18 of the supporting profiles 11, 12—which, along the bottom periphery, form a sideways directed supporting leg 30 for the glass panel 15. The supporting leg 30 has a dimension or width which is somewhat smaller than the width of the glass panel 15. The dimensioning of the transverse profile 14 is selected such that the supporting rollers 26 are accommodated by way of a roller carrier 31 in the transverse profile 14, which is open in the downward direction, between the profile walls 29. The supporting rollers 26 and/or the roller carriers 31 are arranged such that the supporting rollers 26 are arranged, for the most part, within the transverse profile 14. The movable, namely in particular pivotable, roller carrier 31 is U-shaped in cross section and is of a known construction overall.

In a top or inner region, the transverse profile 14 has an integrally formed round profile 32. The latter serves for accommodating a transversely directed connecting element, for example a screw, which passes through the supporting profile 11, 12 and, for the purpose of connecting the profiles, is anchored in the round profile 32.

In the case of the transverse profile 14, a centrally arranged guide groove 23 is formed by upright or inwardly directed groove crosspieces 33 which are fitted on an inner or top terminating wall 34 accommodating the round profile 32. In the case of this transverse profile 14, the adhesive tape 17 is fitted in a top or inner region of the profile walls 29.

The top transverse profile 13 is likewise designed in a particular manner, and comprises two side walls 35 with a crosspiece 36 fitted approximately halfway up or more or less in the center. This crosspiece bounds the guide groove 23, which is open in the inward and downward direction. Furthermore, opposite the guide groove 23, a round profile 32 with the same task as for the bottom transverse profile 14 is fitted on the crosspiece 36. The transverse profile 13 is open in the upward and outward directions.

In order to arrange the guide rollers 27, 28 in the correct position, they are fitted on a roller holder 37 which extends transversely above the element and/or above the transverse profile 13. The two guide rollers 27, 28, which are located one beside the other, are mounted with upright axes of rotation on the roller holder 37. A laterally arranged upright connecting leg of the roller holder 37 is connected in a known manner to the frame 10 and/or the top transverse profile 13.

A securing means is fitted in the region of the top transverse profile 13 in order to secure the external panels, that is to say the glass panels 15, against lifting off from the frame 10 (in the event of inadequacies of bonding). For this purpose, in the case of the present exemplary embodiment, a securing component 38 is fitted in the region of the transverse profile 13. This securing component comprises a transversely directed crosspiece and transversely directed legs or angled portions 42 which are arranged at the ends and surround an outer peripheral region of the glass panel 15. The in particular cross-sectional U-shaped securing component 38 preferably consists of sheet metal or the like and is connected to the top side of the transverse profile 13. In the case of the present exemplary embodiment, the securing component 38 is arranged in the region of the roller holder 37 for the guide rollers 27, 28, namely beneath this holder. The securing component 38 is fixed in position on the frame 10—without any additional connecting means—by the roller holder 37, namely by projecting rivets of the same. As an alternative, it is also possible for the securing component 38 to be fitted independently of the roller holder 37 and, in the extreme case, to extend over the entire length of the transverse profile 13. The angled portions 42 have small dimensions, and therefore cannot be seen from the outside (within a top guide rail).

An important special feature is constituted by auxiliary means for stabilizing the element and for aligning the frame 10, in particular during assembly. The all-round, precisely adjusted guide groove 23, which in the case of a symmetrical profile preferably runs centrally, is provided for this purpose. Means for aligning the adjacent, interconnected profiles enter into this guide grove 23. These means, here, are plate-like elements, namely stabilizing plates 39, 40. In each case the top region and the bottom region of the frame 10 are assigned a stabilizing plate 39, 40, which, accordingly, align respectively top or bottom corner connections of the profiles and secure the same in position relative to one another.

The use of such or similar stabilizing means is important, in particular, for the assembly of the element since the externally fitted glass panels 15 cannot ensure (to a sufficient extent) that the frame 10 is secured. The stabilizing plates 39, 40 also align the abutment surfaces 16 of the adjacent profiles for the adhesive tapes 17. Furthermore, the stability of the element as a whole is increased by the internal, concealed stabilizing plates 39, 40. Instead of individual stabilizing plates of limited size, it is also possible to use a continuous, single-piece stabilizing panel which fills the inner region of the frame 10. On account of the profiles being designed correspondingly, the stabilizing plates 39, 40 are spaced apart from the external glass panel or panels 15, and a stable three-dimensional carrying structure is therefore formed. The guide grooves 23 contain supporting ribs 41, which center and guide the stabilizing plates 39, 40.

The securing and/or stabilizing means may also be designed in some other way, for example as small triangular plate elements in the region of the frame corners (FIG. 10). As an alternative, they may be in the form of angled means which consist, for example, of metal and are positioned as a fitting part in the regions of the frame corners, merely within the guide grooves 23. Since these means are important, in particular, for the assembly of the element, it is possible for the securing means to be removed from the element altogether once the element has been completed.

### LIST OF DESIGNATIONS

10 Frame
11 Supporting profile
12 Supporting profile
13 Transverse profile
14 Transverse profile
15 Glass panel
16 Abutment surface
17 Adhesive tape
18 Side wall
19 Cavity
20 Transverse wall
21 Outer wall
22 Leg
23 Guide groove
24 Supporting leg
25 Groove
26 Supporting roller
27 Guide roller
28 Guide roller
29 Profile wall
30 Supporting leg
31 Roller carrier
32 Round profile
33 Groove crosspiece
34 Terminating wall
35 Side wall
36 Crosspiece
37 Roller holder
38 Securing component
39 Stabilizing plate
40 Stabilizing plate
41 Supporting rib
42 Angled portion
43 Handle

What is Claimed is:

1. Wall, door or window element having at least one filler panel and a frame (10) which is made up of shaped profiles produced by deep drawing or thermoforming and which surrounds the panel along its periphery, wherein:
a) at least one panel (15) is fastened on a free side surface or abutment surface (16) of the frame (10) by a concealed connecting element (17),
b) the profiles (11, 12; 13, 14) are secured, at least in the region of connecting or joining locations, by at least one centering or adjusting means (39, 40) for ensuring precise alignment,
c) the centering or adjusting means (39, 40) enters/enter into guide grooves (23) of the adjacent profiles (11, 12; 13, 14) and/or of the frame (10).

2. Element according to claim 1, wherein the external panel fitted on at least one side of the frame (10) consists of glass or similar material (15) which is fastened on a free, lateral abutment surface (16) of the profiles (11, 12, 13, 14) by a pre-fabricated multi-component adhesive (17).

3. Element according to claim 1, wherein the centering or adjusting means are of plate-like design configured as rigid stabilizing plates (39, 40) which are assigned to a top region of the frame (10), on the one hand, and to a bottom region of the frame (10), on the other hand, the stabilizing plates (39, 40) extending over the entire length of the top transverse profile (13) of the frame (10) and over the entire length of the bottom transverse profile (14) and also over part of the length, or part of the height of upright supporting profiles (11, 12).

4. Element according to claim 3, wherein the guide grooves (23) of the profiles (11, 12; 13, 14), with precise relative positioning, adjoin one another, and run all the way around the inside of the frame (10), centrally in relation to the profiles (11, 12; 13, 14).

5. Element according to claim 1, wherein all the profiles (11, 12; 13, 14) of the frame (10) have sideways directed abutment surfaces (16) on both sides of the profiles (11, 12; 13, 14), for connecting at least one glass panel (15) extending on both sides of the profiles (11, 12; 13, 14), to the frame (10) by adhesive bonding.

6. Element according to claim 1, wherein the upright supporting profiles (11, 12) of the frame (10) have two parallel side walls (18), on the outside of which is formed the abutment surface (16) for the glass panel (15) and in the region of the inside of which is formed the centrally running guide groove (23) comprising legs (22) and a transverse wall (20).

7. Element according to claim 1, wherein the upright supporting profiles (11, 12) and/or the bottom transverse profile (14) of the frame (10) have, in the region of an outer and/or bottom boundary, supporting means (24, 30) for the glass panels (15).

8. Element according to claim 7, wherein the supporting legs (24), in the region of the upright supporting profiles (11, 12), are extended beyond the dimensions of the glass panels (15) and form a lateral projection.

9. Element according to claim 1, wherein a bottom profile of the frame (10), namely a transverse profile (14), is designed as a relatively high hollow body which is open in the downward direction, it being the case that, within the transverse profile (14), supporting rollers (26) are mounted between profile walls (29) and the guide groove (23) is formed, by parallel groove crosspieces (33), on a transversely directed terminating wall (34).

10. Element according to claim 1, wherein a top transverse profile (13) of the frame (10) comprises two parallel side walls (35) which are connected to one another by a crosspiece (36) such that the guide groove (23) is formed on an inner side.

11. Element according to claim 1, wherein the centering or adjusting means, namely the stabilizing plates (39, 40), consist of wood or wood-based material.

12. Element according to claim 8, wherein functional means, namely a handle (43) is, are fitted on the supporting legs (24) of the upright supporting profiles (11, 12).

13. Element according to claim 1, wherein the at least one panel (15) is provided on the inside, which is directed towards the frame (10), with an anti-shatter means applied over the entire surface area.

14. Element according to claim 1, wherein a single centering or adjusting means is configured in the form of a continuous, single-piece stabilizing panel which fills the inner region of the frame (10).
